(19) United States
(12) Patent Application Publication
(10) Pub. No.: US 2012/0117633 A1
(43) Pub. Date: May 10, 2012

(54) Enhanced Security For Pervasive Devices Using A Weighting System

(75) Inventors: Al Chakra, Apex, NC (US); Liam Harpur, Dublin (IE); Mark Kelly, Dublin (IE); John Rice, Waterford (IE)

(73) Assignee: INTERNATIONAL BUSINESS MACHINES CORPORATION, Armonk, NY (US)

(21) Appl. No.: 12/940,024

(22) Filed: Nov. 4, 2010

(51) Int. Cl. H04L 9/32; G06F 21/00

(52) U.S. Cl. 726/7

(57) ABSTRACT

An approach is provided where one or more biometric inputs are received at a biometric receiver accessible by a mobile pervasive computing device. The biometric inputs are from a current user of the mobile pervasive computing device. One or more sets of expected biometric data are retrieved with the sets of expected biometric data corresponding to one or more authorized users of the mobile pervasive computing device. The received biometric inputs are compared with the retrieved sets of expected biometric data. Themobile pervasive computing device is secured using one or more security actions if the comparison reveals a mismatch between the biometric inputs and the retrieved sets of expected biometric data.

### TECHNICAL FIELD

The present invention prevents unauthorized use of a mobile pervasive computing device using biometric inputs. More particularly, the present invention performs security actions, including disabling the device, when an unauthorized user is in possession of the device.

### BACKGROUND

Identifying system users based on biometric features, such as facial recognition, fingerprint analysis, and voice-scan analysis is becoming more ubiquitous in modern systems. Digital data is derived based upon a biometric input, such as a voice scan, a fingerprint scan, etc. This digital data is compared with data previously stored in a data store to determine if the digital data matches an individual whose biometric data is stored in the data store. In the realm of facial recognition, some facial recognition algorithms identify faces by extracting landmarks, or features, from an image of the subject's face. These landmarks may include the relative position, size, and/or shape of the eyes, nose, cheekbones, and jaw. These features are then used to search for other images with matching features. In fingerprint analysis, various patterns are recognized. The three basic patterns of fingerprint ridges are the arch, loop, and whorl. Iris recognition uses camera technology, with subtle infrared illumination reducing specular reflection from the convex cornea, to create images of the detail-rich, intricate structures of the iris. Converted into digital templates, these images provide mathematical representations of the iris that yield unambiguous positive identification of an individual. Finally, speaker, or voice, recognition is the computing task of validating a user's claimed identity using characteristics extracted from their voice.

### SUMMARY

An approach is provided where one or more biometric inputs are received at a biometric receiver accessible by a mobile pervasive computing device. The biometric inputs are from a current user of the mobile pervasive computing device. One or more sets of expected biometric data are retrieved with the sets of expected biometric data corresponding to one or more authorized users of the mobile pervasive computing device. The received biometric inputs are compared with the retrieved sets of expected biometric data. Themobile pervasive computing device is secured using one or more security actions if the comparison reveals a mismatch between the biometric inputs and the retrieved sets of expected biometric data.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 is a network diagram of various types of data processing systems connected via a computer network;

FIG. 3 is a block diagram depicting the components used in a security subsystem utilized on a pervasive computing device;

FIG. 4 is a flowchart depicting steps taken by a mobile pervasive computing device's security subsystem;

FIG. 5 is a flowchart depicting actions taken during the analysis of the biometric input received at the mobile pervasive computing device;

FIG. 6 is a flowchart depicting security actions taken by the mobile pervasive computing device's security subsystem; and

FIG. 7 is a flowchart steps used to set up the mobile pervasive computing device's security subsystem using biometric data.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

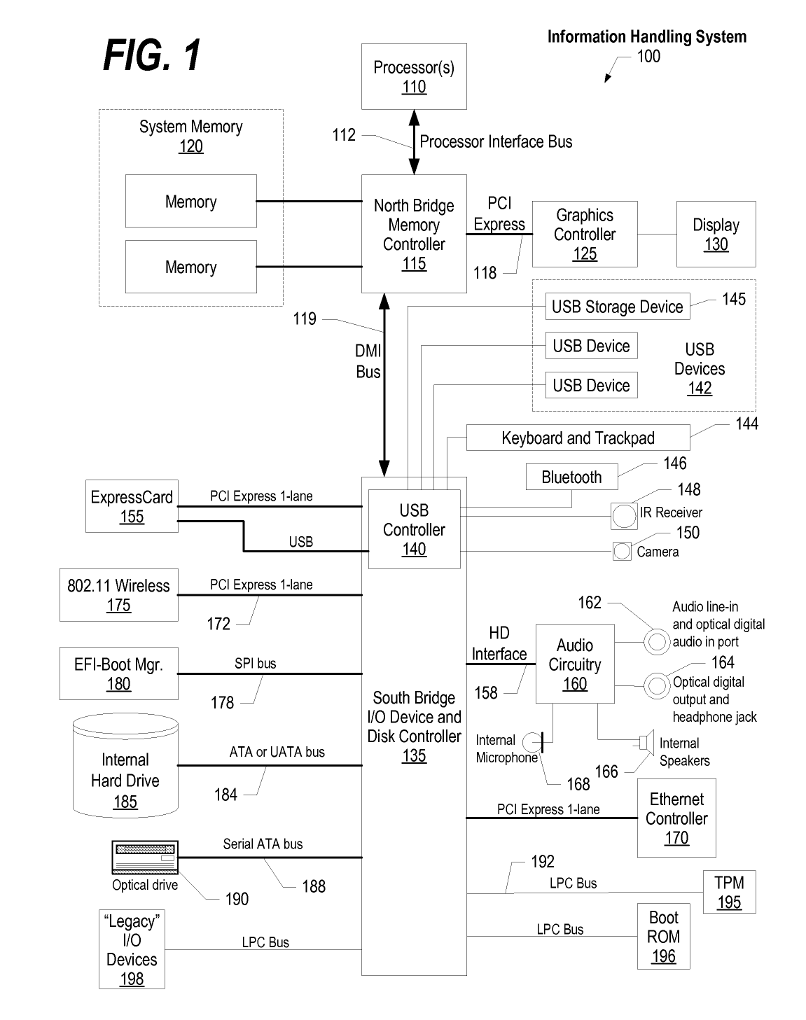

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

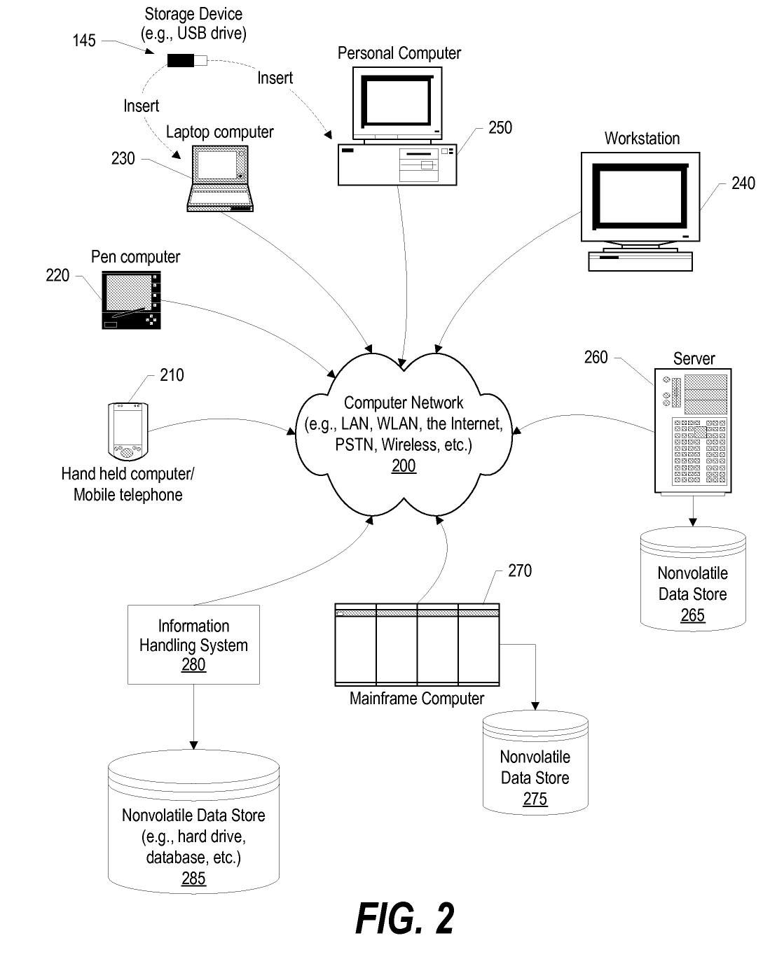

FIG. 2 is a network diagram of various types of data processing systems connected via a computer network. FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

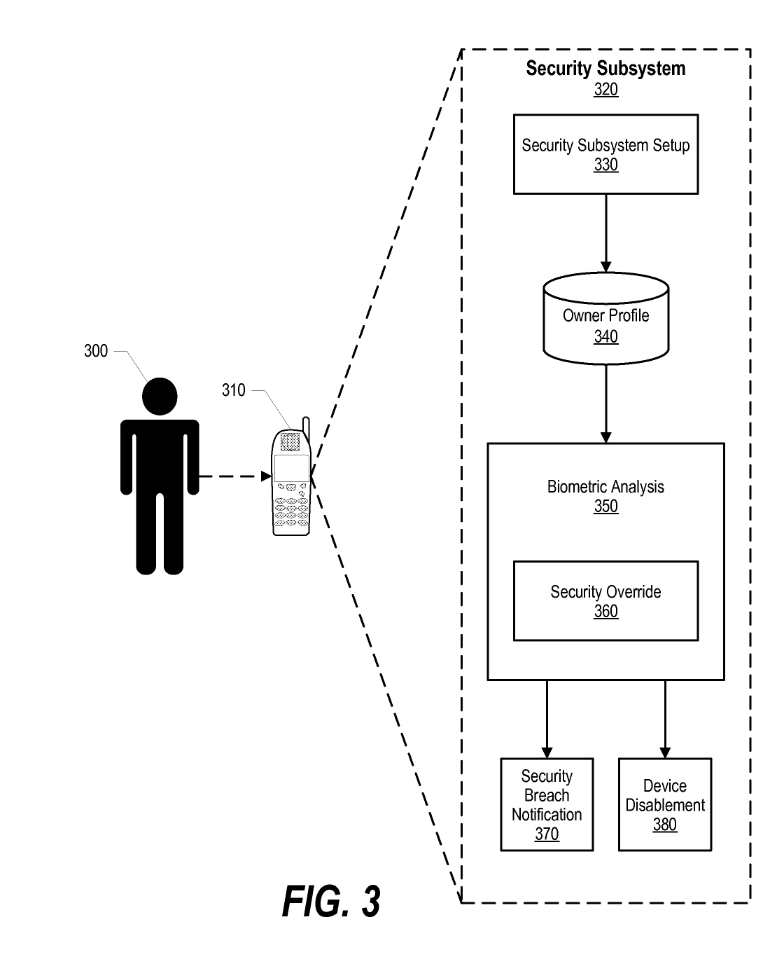

FIG. 3 is a block diagram depicting the components used in a security subsystem utilized on a pervasive computing device. User 300 is the current user of mobile pervasive computing device 310. Mobile pervasive computing device includes one or more biometric receivers such as one or more fingerprint readers on the outside housing of the mobile pervasive computing device, an integrated digital camera that can capture digital images of the user's face and use the images in a facial recognition process, and a microphone into which the user speaks. The speech captured by the microphone is used in communications, such as telephone communications, performed by the user using mobile pervasive computing device 310, as well as in a voice recognition process included in the device to recognize and detect whether user 300 is an authorized user of mobile pervasive computing device 310.

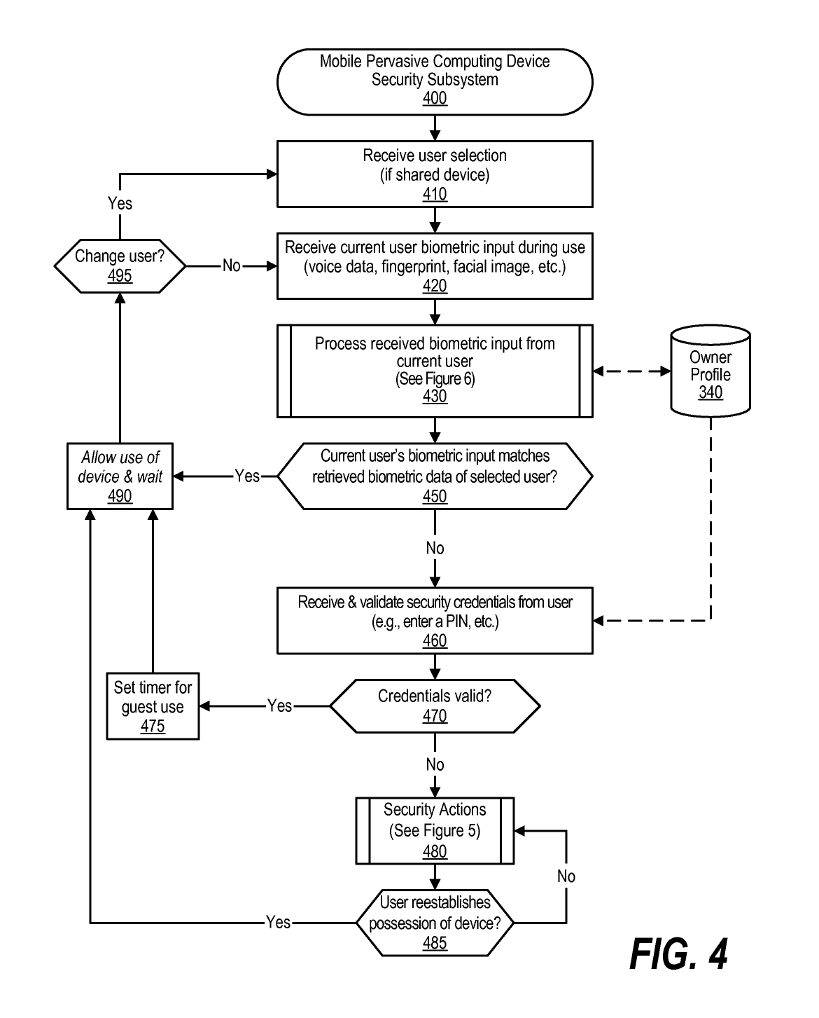

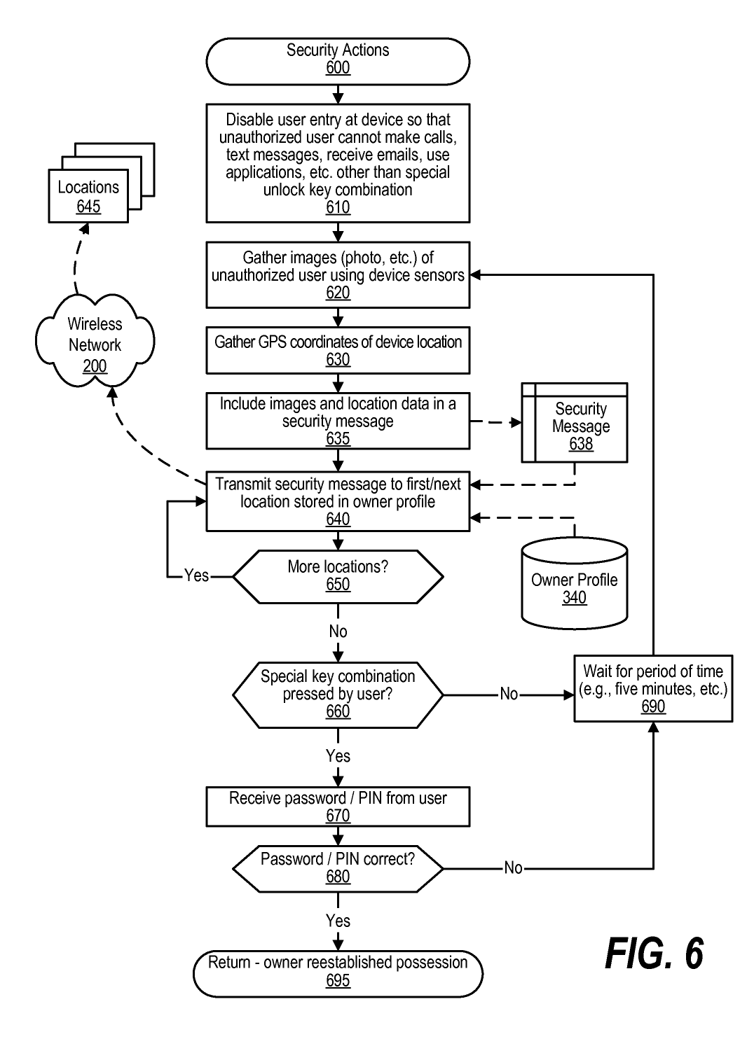

Security subsystem 320 is a set of processes and data stores included in mobile pervasive computing device 310 that are used to secure the device and restrict its use to authorized users. Security subsystem setup process 330 is used to establish the authorized users of mobile pervasive computing device 310 as well as capture biometric data (e.g., voice prints, fingerprints, facial images, etc.) corresponding to the authorized users. In addition, special access codes, such as passwords (including PIN codes) are established by security subsystem setup process 330. Details of the security subsystem setup process are shown in FIG. 6 and described in accompanying text in this detailed description. Data gathered during security subsystem setup process is stored in owner profile data store 340. In one embodiment, data store 340 is a nonvolatile memory within mobile pervasive computing device 310. Biometric analysis process 350 is a process that compares biometric inputs received from current user 300 to the authorized users' biometric data stored in data store 340. Security override 360 is a process that allows a non-authorized user to use the mobile pervasive computing device (e.g., the override can be used to allow a friend to use the authorized user's mobile pervasive computing device for a limited time). Details of the biometric analysis and security override processes are shown in FIG. 4.

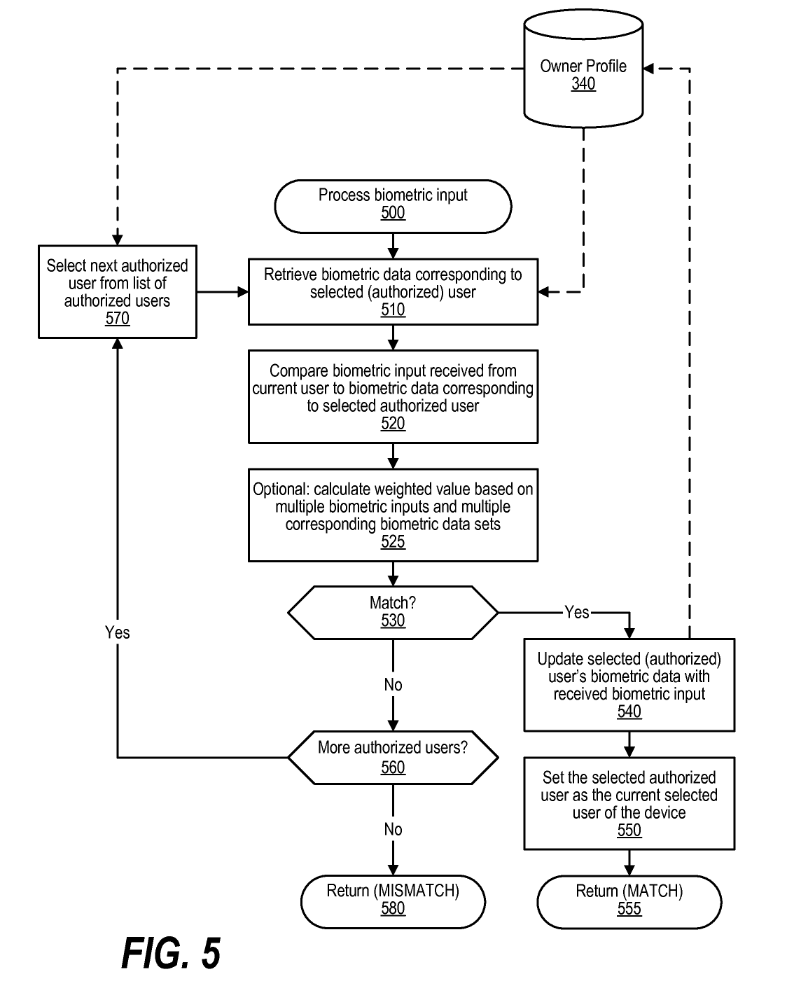

If a non-authorized user, such as a thief, steals or otherwise acquires mobile pervasive computing device 310, the biometric inputs provided by the non-authorized user will not match the biometric data stored in owner profile data store 340 resulting in the execution of security breach notification process 370 and device disablement process 380. Details of the security breach notification process and the device disablement process are shown in FIG. 5.

FIG. 4 is a flowchart depicting steps taken by a mobile pervasive computing device's security subsystem. Processing commences at 400 whereupon, at step 410, an authorized user selection is received if the mobile pervasive computing device is a shared device that is being used at different times by different users. For example, if “Jane” and “John” share the mobile pervasive computing device, then the current user (e.g., “Jane”) would indicate their identity using one of a variety of methods, such as a dialog selection from a touch-enabled screen, by voice identification when the current user speaks into the device's microphone, etc.

At step 420, the security subsystem receives biometric input from the current user of the mobile pervasive computing device during use of the device by the current user. The biometric input can be any biometric input data that can be gathered using a receiver accessible from the mobile pervasive computing device, such as a fingerprint image received at a fingerprint reader mounted on an exterior housing of the device, voiceprint data received at a microphone included in the device (e.g., while the user is communicating using the mobile pervasive computing device as a telephone, etc.), or any other sort of biometric data that can be received at the mobile pervasive computing device while the user is using the device.

At step 430, the profile of the biometric data corresponding to the selected (authorized) user is retrieved from owner profile data store 340. The biometric data is the same type of biometric data that was received in step 420 (e.g., fingerprint data, voiceprint data, etc.).

At step 440, the received biometric input that was received from the current user of the mobile pervasive computing device from step 420 is analyzed against the retrieved biometric data that corresponds to the selected user of the device that was retrieved in step 430. A decision is made as to whether the current user's biometric input matches the retrieved biometric data that corresponds to the selected authorized user (decision 450). If the current user's biometric input matches the retrieved biometric data, authenticating the identity of the current user, then decision 450 branches to the “yes” branch whereupon the authorized user utilizes the mobile pervasive computing device for a period of time (e.g., five minutes, etc.) before processing loops back to start the process again. On the other hand, if the current user's biometric input does not match the retrieved biometric data (a mismatch occurs), then decision 450 branches to the “no” branch for further security subsystem processing.

At step 460, the current user is requested to provide a security credential, such as a password (e.g., PIN code, etc.) that is received at the mobile pervasive computing device (e.g., using a keypad included in the device, voice recognition of the password, etc.). During this step (460), the password provided by the current user is validated by comparing with a password stored in owner profile data store 340. A decision is made as to whether the password is valid (decision 470). One situation where a password might be used in lieu of a biometric match would be when the authorized user lends the mobile pervasive computing device to someone, such as a friend or relative, for temporary use. If the password is valid, then decision 470 branches to the “yes” branch whereupon, at step 475, a timer is set for the non-authorized “guest” user to use the mobile pervasive computing device. In one embodiment, at step 475, the user specifies the amount of time to set the timer (e.g., one hour, etc.). At step 490, the guest user uses the mobile pervasive computing device for the prescribed amount of “guest” use time, after which decision 495 determines whether the current user of the mobile pervasive computing device has changed. If the current user of the mobile pervasive computing device has changed, then decision 495 branches to the “yes” branch which loops back to step 410 to receive the identifier of the current user of the device. On the other hand, if the user has not changed, then decision 495 branches to the “no” branch which loops back to step 420 to receive further biometric input from the current user and compare the biometric input to the biometric data retrieved for the selected user, as described above.

Returning to decision 470, if the password provided by the user is not valid (e.g., indicating that a thief or other malevolent user may be in possession of the mobile pervasive computing device, etc.), then decision 470 branches to the “no” branch whereupon, at predefined process 480, security actions are performed (see FIG. 5 and corresponding text for processing details). Periodically, a decision is made as to whether one of the authorized users has reestablished possession of the mobile pervasive computing device (decision 485). If an authorized user reestablishes possession of the mobile pervasive computing device, then decision 485 branches to the “yes” branch whereupon, at step 490 the user is allowed to use the device for a period of time (e.g., five minutes, etc.) before a decision is made as to whether the user has been changed branching to either the “yes” branch (looping back to step 410 if the user has been changed), or the “no” branch (looping back to step 420 if the user has not been changed). However, if one of the authorized users has not reestablished possession of the device, then decision 485 branches to the “no” branch which continues securing the device using predefined process 485 and as further described in FIG. 5 and corresponding text found in the detailed description.

FIG. 5 is a flowchart depicting actions taken during the analysis of the biometric input received at the mobile pervasive computing device. Processing commences at 500 whereupon, at step 510, the process retrieves biometric data from owner profile data store 340 with the retrieved data corresponding to the selected (authorized) user of the mobile pervasive computing device. At step 520, the biometric input that was received from the current user is analyzed and compared to the retrieved biometric data that corresponds to the selected authorized user. In one embodiment, non-biometric data is also gathered that may include phone numbers dialed by the user, phone numbers that call the user, GPS locations or routes that the user frequents, key stroke timing and the like. A decision is made as to whether the biometric input matches the biometric data, indicating that the selected user is the same person as the current user of the mobile pervasive computing device (decision 530). In one embodiment, more than one biometric data can be used to form multiple factors. At step 525, a weighted value is calculated based on a these factors (biometric inputs compared against corresponding biometric data sets). In one embodiment, further non-biometric factors are used, separately or in conjunction with, the biometric factors used in the calculation performed at step 525. The biometric inputs and data may include fingerprint scans, voiceprint scans, and the like, while the non-biometric inputs and data may include phone numbers dialed by the user, phone numbers dialing the device, websites accessed by the device, and pattern of user input (e.g., keypad entry) at the device. In one embodiment, these various biometric and non-biometric factors are processed using a weighted algorithm at step 525. Using the results from the weighted algorithm, a deviation is calculated. If the deviation exceeds a given threshold, then a mismatch is deemed to have occurred (e.g., the current user does not match the authorized user).

If the biometric input matches the biometric data, then decision 530 branches to the “yes” branch whereupon, at step 540, the selected user's biometric data is updated based upon the received biometric input. As described above, decision 530 may be based upon a weighted value calculated in optional step 525. In one embodiment, the additional biometric input provides a learning feedback loop to enhance the user's biometric data as well as to provide a more accurate biometric depiction of the user. That is, a history of the user's use of the device is used to build the user's profile. The history may include both biometric and non-biometric data particular to the user. The biometric data may include voice prints, fingerprint data, etc., while the non-biometric data may include phone numbers dialed by the user, phone numbers that call the user, GPS locations or routes that the user frequents, key stroke timing and the like. At step 550, the selected authorized user is set as the current selected user of the device which might replace the user selection that was made in step 410 shown in FIG. 4 (e.g., the authorized user of the device may have changed as one authorized user handed the device to a different authorized user, etc.). Returning to FIG. 5, processing then returns to the calling routine (see FIG. 4) at 555 indicating that a “match” was identified.

Returning to decision 530, if the biometric input does not match the biometric data, then decision 530 branches to the “no” branch whereupon a decision is made as to whether there are more authorized users of the device that might be currently using the device (decision 560). If there are more authorized users of the device, decision 560 branches to the “yes” branch whereupon, at step 570, the next authorized user of the device is selected from owner profile data store 340 and processing loops back to step 510 to compare the newly selected authorized user's biometric data with the received biometric input as described above. This looping continues until either one of the authorized user's biometric data matches the received biometric input (decision 530 branching to the “yes” branch), or until there are no more authorized users of the device, at which point decision 560 branches to the “no” branch and processing returns to the calling routine (see FIG. 4) at 580 indicating that a “mismatch” was identified (FIG. 4 will then initiate security actions described in FIG. 6).

FIG. 6 is a flowchart depicting security actions taken by the mobile pervasive computing device's security subsystem. Security action processing commences at 600 whereupon, at step 610, the mobile pervasive computing device is disabled so that use of the device by the current user is prevented (e.g., keypad is disabled, microphone is disabled, etc.). In one embodiment, a special keypad combination (e.g., pressing a series of keys simultaneously, etc.) is not disabled so that, when an authorized user reestablishes possession of the device, the user can press the special keypad combination and enter a password (e.g., a PIN code, etc.) to unlock the device.

At step 620, while the device is disabled from user input, the security subsystem takes control of biometric readers installed on the mobile pervasive computing device (e.g., digital camera, the microphone, fingerprint reader, etc.) in order to capture images (facial images, voice images, fingerprint images, etc.) that might prove useful in identifying and perhaps apprehending the unauthorized user of the mobile pervasive computing device.

At step 630, the geographic location of the mobile pervasive computing device is gathered using positioning component in the device, such as a GPS receiver, a triangulation receiver, etc. At step 635, the images captured in step 620 and the geographic location data gathered in step 630 are included in a security message that is stored in memory 638.

At step 640, the first location stored in owner profile data store 340 is retrieved and the security message stored in memory 635 (that includes the images, geographic location, etc.) is transmitted through wireless network 200 to the selected location (e.g., another mobile pervasive computing device used by the authorized user, a security service, the police department, etc.). At step 650, a decision is made as to whether there are more locations that the authorized user of the device has selected to receive messages during a security breach (decision 650). If there are more locations, then decision 650 branches to the “yes” branch which loops back to select the next location from owner profile 340 and send the security message to the selected location. This looping continues until all of the locations have been sent the security message, at which point decision 650 branches to the “no” branch for further security action processing.

A decision is made as to whether a current user has pressed a special key combination on the keypad of the mobile pervasive computing device (decision 660), such as by pressing certain keys simultaneously. If the special key combination was received, then decision 660 branches to the “yes” branch whereupon, at step 670 the current user is requested to provide a security credential, such as a password (e.g., PIN code, etc.) that is received at the mobile pervasive computing device (e.g., using a keypad included in the device, voice recognition of the password, etc.). During this step (570), the password provided by the current user is validated by comparing with a password stored in owner profile data store 340. A decision is made as to whether the password is valid (decision 680). If the password is validated, then decision 680 branches to the “yes” branch whereupon processing returns to the calling routine (see FIG. 4) at 695. On the other hand, if either the special key combination was not received (decision 660 branching to the “no” branch), or if the password entered by the current user was not correct (decision 680 branching to the “no” branch), then processing waits for a period of time (e.g., five minutes) at step 690 before looping back to gather more images and updated geographic location data and resending an updated security message to one or more locations. This looping continues, with the device being disabled for use by the current user, until possession of the device is reestablished by entry of the correct password (with decision 680 branching to the “yes” branch and returning at 695).

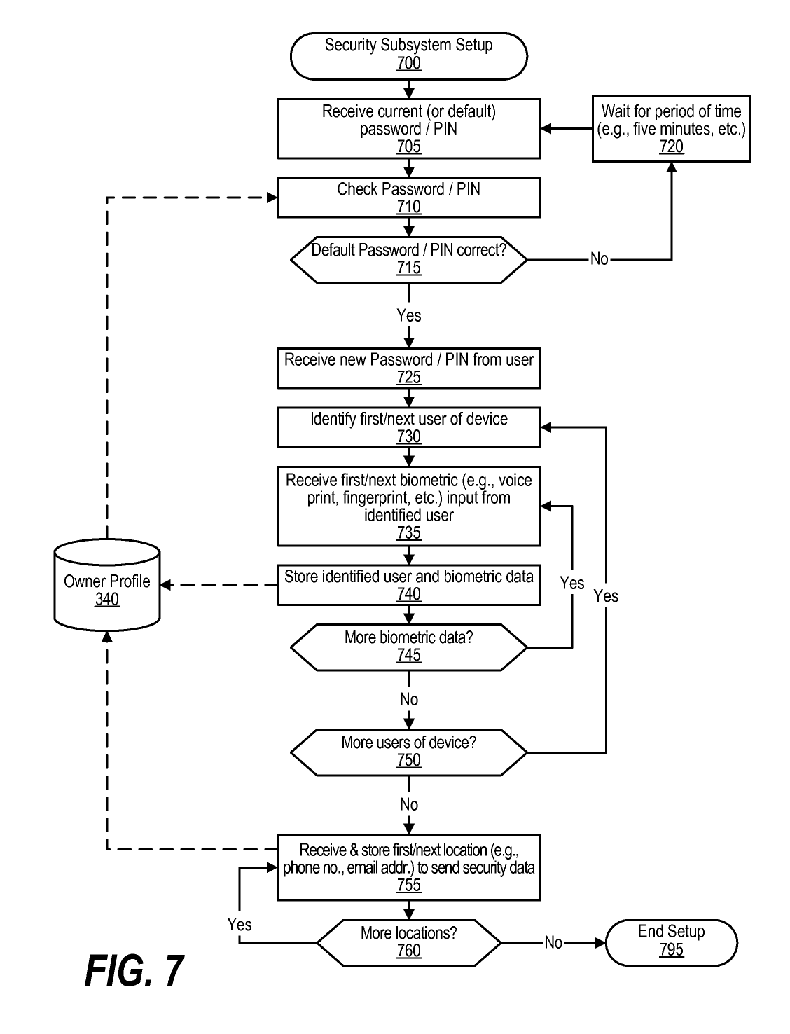

FIG. 7 is a flowchart steps used to set up the mobile pervasive computing device's security subsystem using biometric data. Security subsystem setup processing commences at 700 whereupon, at step 705, the current user of the mobile pervasive computing device enters a password (e.g., PIN code, etc.) that is received by the device. At step 710, the received password is checked against the correct password which is stored in owner profile data store 340. A decision is made as to whether the correct password was entered by the user (decision 715). Note that in a first execution of the setup process, a default password set by the manufacturer of the mobile pervasive computing device may be used until the user sets a different password for the device. If the password entered is not correct, then decision 715 branches to the “no” branch whereupon, at step 720, processing waits for a period of time (e.g., five minutes) before looping back to allow the user to retry entry of the correct password. This wait period is designed to thwart would-be thieves of quickly and repeatedly retrying passwords in order to break into the security subsystem setup. On the other hand, if the password entered by the user is correct, then decision 715 branches to the “yes” branch for further setup processing.

At step 725, a new password can be entered by the user if the user desires to change the password (e.g., PIN code, etc.) or if the default password is currently being used by the device. At step 730, the first user of the mobile pervasive computing device is identified (e.g., “John”, “Jane”, etc.). At step 735, the system receives the first biometric input data from the identified user. The biometric data can be a voiceprint, a fingerprint, a facial image, or any other biometric input data. At step 740, the identified user is stored in owner profile data store 340 along with the received biometric data. This biometric data will be used during the processing shown in FIG. 4 to identify a current user of the device. Returning to FIG. 7, a decision is made as to whether there is more biometric data that is being provided for the identified user (decision 745). If there is more biometric data for the identified user, then decision 745 branches to the “yes” branch which loops back to step 735 to receive more biometric input data from the identified user. This looping continues until no more biometric data is to be given for the identified user, at which point decision 745 branches to the “no” branch whereupon another decision is made as to whether there are more authorized users of the device that need to be identified (decision 750). If there are more users of the device, then decision 750 branches to the “yes” branch which loops back to step 730 for the identification of the next user of the device followed by the looping through the receipt of the next user's biometric input data. Decision 750 keeps branching to the “yes” branch until there are no more users to identify and enter at the mobile pervasive computing device, at which point decision 750 branches to the “no” branch.

At step 755, the user provides the first location, such as a phone number, email address, etc., that should receive security messages as part of the security actions described in FIG. 6. Step 755 also stores the received location information in owner profile data store 340. A decision is made as to whether there are more locations that should receive the security messages (decision 760). If there are more locations, then decision 760 branches to the “yes” branch which loops back to receive and store the next location. This looping continues until there are no more locations to enter, at which point decision 760 branches to the “no” branch and setup processing ends at 795.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by a mobile pervasive computing device, the method comprising:
receiving one or more biometric inputs at a biometric receiver accessible by the mobile pervasive computing device, the biometric inputs based on a current user of the mobile pervasive computing device;
retrieving one or more sets of expected biometric data corresponding to one or more authorized users of the mobile pervasive computing device;
comparing the received biometric inputs with the retrieved sets of expected biometric data; and
securing the mobile pervasive computing device using one or more security actions in response to the comparison revealing a mismatch between the biometric inputs and the retrieved sets of expected biometric data.

2. The method of claim 1 wherein the securing further comprises:
receiving a password from the current user at a keypad included in the mobile pervasive computing device;
analyzing the received password; and
disabling a user interface function included in the mobile pervasive computing device in response to the analysis revealing that the received password does not match an expected password stored in a memory of the mobile pervasive computing device.

3. The method of claim 2 further comprising:
identifying a geographic location corresponding to the mobile pervasive computing device based on a positioning component included in the mobile pervasive computing device;
creating a security message that includes the identified geographic location; and
wirelessly transmitting the security message to one or more receivers through a wireless network.

4. The method of claim 3 further comprising:
capturing one or more digital images of the current user using a digital camera included in the mobile pervasive computing device; and
including the captured digital images in the security message.

5. The method of claim 1 wherein the biometric input is a voice recognition scan, the method further comprising:
receiving, at a microphone included in the mobile pervasive computing device, vocal input from the current user during use of the mobile pervasive computing device;
digitizing the received vocal input into a digital vocal stream; and
converting the digital vocal stream into the biometric input.

6. The method of claim 1 wherein the biometric input includes a plurality of biometric inputs and wherein the expected biometric data includes a plurality of biometric data sets, the method further comprising:
analyzing the plurality of biometric inputs against the plurality of biometric data sets, the analysis resulting in a weighted value; and
identifying the mismatch based upon the resulting weighted value.

7. The method of claim 1 further comprising:
receiving non-biometric user-based inputs from a current user of the mobile pervasive computing device;
retrieving one or more sets of expected non-biometric data corresponding at least one of the authorized users of the mobile pervasive computing device;
comparing the received non-biometric inputs with the retrieved sets of expected non-biometric data;
calculating a score based on a first deviation between the received biometric inputs and the retrieved sets of expected biometric data and a second deviation between the received non-biometric inputs and the retrieved sets of expected non-biometric data,
performing the securing of the mobile pervasive computing device in response to determining that the current user is inapposite to any of the authorized users based upon the calculated score; and
updating the stored biometric data and the stored non-biometric data using the received biometric inputs and the received non-biometric inputs in response to determining that the current user corresponds to one of the authorized users based upon the calculated score.

8. A mobile pervasive computing device comprising:
one or more processors;
a memory coupled to at least one of the processors;
a set of instructions stored in the memory and executed by at least one of the processors in order to perform actions of:
receiving one or more biometric inputs at a biometric receiver accessible by the mobile pervasive computing device, the biometric inputs based on a current user of the mobile pervasive computing device;
retrieving one or more sets of expected biometric data corresponding to one or more authorized users of the mobile pervasive computing device;
comparing the received biometric inputs with the retrieved sets of expected biometric data; and
securing the mobile pervasive computing device using one or more security actions in response to the comparison revealing a mismatch between the biometric inputs and the retrieved sets of expected biometric data.

9. The information handling system of claim 8 wherein the securing action includes further actions comprising:
receiving a password from the current user at a keypad included in the mobile pervasive computing device;
analyzing the received password; and
disabling a user interface function included in the mobile pervasive computing device in response to the analysis revealing that the received password does not match an expected password stored in a memory of the mobile pervasive computing device.

10. The information handling system of claim 9 wherein the processors perform further actions comprising:
identifying a geographic location corresponding to the mobile pervasive computing device based on a positioning component included in the mobile pervasive computing device;
creating a security message that includes the identified geographic location; and
wirelessly transmitting the security message to one or more receivers through a wireless network.

11. The information handling system of claim 10 wherein the processors perform further actions comprising:
capturing one or more digital images of the current user using a digital camera included in the mobile pervasive computing device; and
including the captured digital images in the security message.

12. The information handling system of claim 8 wherein the biometric input is a voice recognition scan, and wherein the processors perform further actions comprising:
receiving, at a microphone included in the mobile pervasive computing device, vocal input from the current user during use of the mobile pervasive computing device;
digitizing the received vocal input into a digital vocal stream; and
converting the digital vocal stream into the biometric input.

13. The information handling system of claim 8 wherein the processors perform further actions comprising:
receiving non-biometric user-based inputs from a current user of the mobile pervasive computing device;
retrieving one or more sets of expected non-biometric data corresponding at least one of the authorized users of the mobile pervasive computing device;
comparing the received non-biometric inputs with the retrieved sets of expected non-biometric data;
calculating a score based on a first deviation between the received biometric inputs and the retrieved sets of expected biometric data and a second deviation between the received non-biometric inputs and the retrieved sets of expected non-biometric data,
performing the securing of the mobile pervasive computing device in response to determining that the current user is inapposite to any of the authorized users based upon the calculated score; and
updating the stored biometric data and the stored non-biometric data using the received biometric inputs and the received non-biometric inputs in response to determining that the current user corresponds to one of the authorized users based upon the calculated score.

14. A computer program product stored in a computer readable medium, comprising functional descriptive material that, when executed by an information handling system, causes the information handling system to perform actions that include:
receiving one or more biometric inputs at a biometric receiver accessible by the mobile pervasive computing device, the biometric inputs based on a current user of the mobile pervasive computing device;
retrieving one or more sets of expected biometric data corresponding to one or more authorized users of the mobile pervasive computing device;
comparing the received biometric inputs with the retrieved sets of expected biometric data; and
securing the mobile pervasive computing device using one or more security actions in response to the comparison revealing a mismatch between the biometric inputs and the retrieved sets of expected biometric data.

15. The computer program product of claim 15 wherein the securing action includes further actions comprising:
receiving a password from the current user at a keypad included in the mobile pervasive computing device;
analyzing the received password; and
disabling a user interface function included in the mobile pervasive computing device in response to the analysis revealing that the received password does not match an expected password stored in a memory of the mobile pervasive computing device.

16. The computer program product of claim 16 wherein the actions further comprise:
identifying a geographic location corresponding to the mobile pervasive computing device based on a positioning component included in the mobile pervasive computing device;
creating a security message that includes the identified geographic location; and
wirelessly transmitting the security message to one or more receivers through a wireless network.

17. The computer program product of claim 17 wherein the actions further comprise:
capturing one or more digital images of the current user using a digital camera included in the mobile pervasive computing device; and
including the captured digital images in the security message.

18. The computer program product of claim 15 wherein the biometric input is a voice recognition scan, and wherein the actions further comprise:
receiving, at a microphone included in the mobile pervasive computing device, vocal input from the current user during use of the mobile pervasive computing device;
digitizing the received vocal input into a digital vocal stream; and
converting the digital vocal stream into the biometric input.

19. The computer program product of claim 15 wherein the biometric input includes a plurality of biometric inputs, wherein the expected biometric data includes a plurality of biometric data sets, and wherein the actions further comprise:
analyzing the plurality of biometric inputs against the plurality of biometric data sets, the analysis resulting in a weighted value; and
identifying the mismatch based upon the resulting weighted value.

20. The computer program product of claim 15 wherein the actions further comprise:
receiving non-biometric user-based inputs from a current user of the mobile pervasive computing device;
retrieving one or more sets of expected non-biometric data corresponding at least one of the authorized users of the mobile pervasive computing device;
comparing the received non-biometric inputs with the retrieved sets of expected non-biometric data;
calculating a score based on a first deviation between the received biometric inputs and the retrieved sets of expected biometric data and a second deviation between the received non-biometric inputs and the retrieved sets of expected non-biometric data,
performing the securing of the mobile pervasive computing device in response to determining that the current user is inapposite to any of the authorized users based upon the calculated score; and
updating the stored biometric data and the stored non-biometric data using the received biometric inputs and the received non-biometric inputs in response to determining that the current user corresponds to one of the authorized users based upon the calculated score.
